(19) United States
(12) Patent Application Publication
(10) Pub. No.: US 2007/0078046 A1
(43) Pub. Date: Apr. 5, 2007

(54) Conductive rubber roller for oa and process for producing the same

(76) Inventor: Shigenori Matsumura, Hirakata-shi (JP)

Correspondence Address: BIRCH STEWART KOLASCH & BIRCH, PO BOX 747, FALLS CHURCH, VA, 22040-0747, US

(21) Appl. No.: 10/575,778

(22) PCT Filed: Oct. 8, 2004
(86) PCT No.: PCT/JP04/14929

§ 371 Date: Apr. 13, 2006

(30) Foreign Application Priority Data
Oct. 27, 2003 (JP) 2003-365511

(51) Int. Cl. F16C 13/00

(52) U.S. Cl. 492/56; 29/895.32

(57) ABSTRACT

A conductive rubber roller for OA that realizes semipermanent recycling of rubber part, enabling cost reduction and excelling in effective exploitation of resources. There is provided a conductive rubber roller for OA characterized by containing a recycled rubber. It is preferred that the conductivity of the rubber roller be provided by ionic conduction or electronic conduction. It is also preferred that the ratio of recycled rubber to the rubber part of the rubber roller be in the range of 5 to 50 mass %. The rubber roller can preferably be obtained by a process characterized by including the steps of micropulverizing the rubber separated from rubber roller to thereby obtain a micropulverized rubber; increasing the fluidity of the micropulverized rubber through physical treatment and/or heat treatment to thereby obtain a recycled rubber; and mixing the recycled rubber with virgin rubber.

### TECHNICAL FIELD

The present invention relates to a conductive rubber roller for OA, employing recycled rubber, preferably usable for an imager such as an electronic photocopier, a printer or a facsimile.

### BACKGROUND ART

In general, corona discharge is generally employed as a method of charge treatment in a transferrer or charger used for an imager such as an electronic photocopier, a printer or a facsimile. Corona discharge, requiring a high applied voltage in order to obtain a desired charge quantity, results in a problem in environmental sanitation due to generation of a large quantity of ozone.

As a countermeasure against this problem, a transferrer or a charger, employing the so-called contact type transfer or charge roller, performing transfer/charge by bringing a roller-shaped voltage application member into contact with a photosensitive body has recently been used. A contact type transfer roller, chargeable with a lower applied voltage as compared with a corona charge type one, has such an advantage that the quantity of generation of ozone is extremely small.

However, the contact type transfer or charge roller is extremely easily stained with toner. When a resistance value which is an important function of the transfer or charge roller increases due to toner stain, a failure such as a transfer failure or an uneven image results, while such a problem arises that the back surface of a copy paper is stained due to the stain of the roller. Therefore, the roller must be exchanged at least several times before the overall apparatus reaches the end of its life, and the exchanged rollers are generally discarded as consumables.

On the other hand, there is also a noncontact type charge or transfer roller as a developed contact type one. In the noncontact type roller, a small clearance is provided between the roller and a photosensitive body, for preventing print-through resulting from an excessive contact pressure between the roller and the photosensitive body while taking over such an advantage of the contact type roller that the quantity of generation of ozone is extremely small. However, exchange of the roller is inevitable since toner scatters in the apparatus also in the case of the noncontact type one, and the exchanged rollers are discarded as consumables.

As a method of solving the aforementioned problems related to stain and exchange of the roller, Patent Literature 1 proposes a method of recycling the roller by mechanically polishing a toner stain part on the back surface. However, this method is unsuitable for a noncontact type mechanism since the outer diameter of the roller is reduced due to the mechanical polishing. Also in relation to a contact type mechanism, the recycling frequency is problematically limited.

Patent Literature 2 proposes a method of separately recycling each material by separating a periodically exchanged imaging roller into a core bar and a conductive rubber roller with a cutter. However, no specific recycling method is taken into consideration in relation to this method, and hence there is a possibility for such a problem that the physical properties of recycled products cannot be sufficiently ensured if neither application nor method of the recycling is taken into consideration. Further, the recycling frequency is generally limited, and this method must still be improved also in view of global greening.

Patent Literature: Japanese Patent Laying-Open No. 7-205336

Patent Literature 2: Japanese Patent Laying-Open No. 8-22164

### DISCLOSURE OF THE INVENTION

Problems to be Solved by the Invention In order to solve the aforementioned problems, the present invention provides a conductive rubber roller for OA, capable of semipermanently recycling a rubber part, capable of reducing the cost and excellent also in a point of effective exploitation of resources.

### MEANS FOR SOLVING THE PROBLEMS

The present invention relates to a conductive rubber roller for OA recycling a rubber part separated from a used rubber roller for employing the same as the rubber part of the rubber roller again. According to the present invention, rubber recycled from the rubber roller is employed as the material for the rubber roller again, whereby semipermanent circulation is enabled and the resources can be effectively exploited. Further, the rubber roller according to the present invention has such advantages that the compositions of the recycled material and a virgin material are common since recycling is repeated for the same application, and that the physical properties are hardly reduced due to the repetition of recycling.

While such a possibility that the rubber part of the conductive rubber roller according to the present invention is prepared from only recycled rubber is not excluded, the rubber part is preferably blended with virgin rubber, in order to attain superior performance. The content of the recycled rubber in the rubber part is 5 to 50 mass %, and particularly preferably set in the range of 10 to 30 mass

The conductive rubber roller according to the present invention is preferably provided with conductivity by electronic conduction such as ionic conduction or carbonic conduction in particular.

The present invention also relates to a process for producing a conductive rubber roller for OA, including steps of obtaining micropulverized rubber by micropulverizing rubber separated from a rubber roller, obtaining recycled rubber by increasing fluidity of the micropulverized rubber by physical treatment and/or heat treatment, and mixing the recycled rubber with virgin rubber.

### EFFECTS OF THE INVENTION

In the conductive rubber roller according to the present invention, the recycled rubber obtained by separating only a rubber part from the rubber roller is employed as that for the conductive roller again, whereby a recycled rubber roller can be produced without remarkably reducing the physical properties of the rubber part. Further, the rubber roller can be semipermanently recycled by using a recovered rubber part for the same application, thereby enabling reduction of the cost and effective exploitation of resources.

### BRIEF DESCRIPTION OF THE DRAWING

FIG. 1 is a sectional view showing the structure of a conductive rubber roller according to the present invention.

### DESCRIPTION OF REFERENCE NUMERALS

1 rubber part, 2 core bar.

### BEST MODES FOR CARRYING OUT THE INVENTION

A conductive rubber roller for OA according to the present invention contains recycled rubber in a rubber part. The content of the recycled rubber in the rubber part is 5 to 50 mass %, particularly preferably in the range of 10 to 30 mass %. It is possible to sufficiently contribute to the object of effectively exploiting resources if the content of the recycled rubber is at least 5 mass %, while the physical properties of the rubber part can be kept at levels equivalent to those of a rubber part consisting of only virgin rubber.

The conductive rubber roller according to the present invention can be provided with conductivity by ionic conduction or electronic conduction, and any method can be properly selected in response to the service condition or the object of an OA apparatus such as an electronic photocopier, a printer or a facsimile to which this rubber roller is applied.

A method of dispersing a rubber component or a filler exhibiting ion conductivity into a rubber composition or the like can be listed as a method of providing the rubber part with ion conductivity. Polar rubber is preferably employed as the rubber component exhibiting ion conductivity, and more specifically, epichlorohidrin rubber, urethane rubber, nitrile-butadiene rubber, acrylic rubber, chloroprene rubber, fluororubber, nitrile rubber, norbornene rubber or the like can be listed. As the filler exhibiting ion conductivity, quaternary ammonium salt such as lauryl trimethylammonium chloride, stearyl trimethylammonium chloride, octadecyl trimethylammonium chloride, hexadecyl trimethylammonium chloride, denatured aliphatic dimethylethylammonium ethosulfate, tetraethylammonium perchlorate, tetrabutylammonium perchlorate, tetrabutylammonium borofluoride, tetraethylammonium borofluoride or tetrabutylammonium chloride as well as perchlorate, alkyl sulfonate or phosphate can be listed in addition to inorganic salt such as lithium perchlorate, sodium perchlorate or calcium perchlorate. The rubber component or the filler may be singularly employed, or at least two types may be combinedly employed.

It is relatively easy to homogeneously disperse the rubber component and the filler exhibiting ion conductivity into a rubber composition, whereby a rubber roller employing an ion-conductive rubber composition is advantageous in such points that a stable electric resistance value is obtained, that the difference between electric resistance values upon low voltage application and high voltage application is small, and that the electric resistance value is not influenced by the applied voltage.

On the other hand, a method of employing a rubber composition into which a conductive material such as carbon or a metal oxide is dispersed for the rubber part of the roller or the like can be listed as a method of providing the rubber part with electronic conductivity. While it is difficult to homogeneously disperse a conductive material such as carbon or a metal oxide into the rubber composition as compared with a case of dispersing an ion-conductive material into the rubber composition, a rubber roller employing electronic conduction is advantageous in a point that the same is hardly influenced by the temperature and the moisture of the service condition since fluctuation of the electric resistance value hardly results from water absorption of the rubber part or the like. Further, the rubber composition having electronic conductivity can be produced at a low cost, whereby the same is advantageous also in a point that the cost for the rubber roller can be reduced.

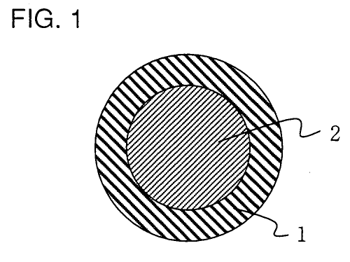

FIG. 1 is a sectional view showing the structure of a conductive rubber roller according to the present invention. The conductive rubber roller according to the present invention is typically so constituted that a rubber part 1 covers the periphery of a core bar 2.

The conductive rubber roller according to the present invention can be produced through the following process, for example. First, a used rubber roller is first separated into a rubber part and a core bar, and the obtained rubber part is micropulverized with a milling rolls of 10 inches, for example. Further, physical treatment and/or heat treatment is applied for increasing fluidity of the micropulverized rubber.

A method of effectuating shearing force and heat by gradually narrowing the roll width in the milling rolls to finally unlimitedly approximate zero clearance or the like can be employed as the method of physical treatment or heat treatment. According to this method, recycled rubber easily mixable with virgin rubber can be obtained without remarkably reducing the physical properties. This is conceivably because bonds forming crosslinked structures are more easily cut than bonds of rubber molecular backbones and the crosslinked structures are preferentially cut when bonds of rubber molecules are cut through the shearing force and the heat acting on the micropulverized rubber. In the physical treatment and/or the heat treatment, it is preferable to control physical or chemical treatment conditions for preferentially cutting the crosslinked structures while avoiding cutting of the rubber molecular backbones so that the micropulverized rubber can attain desired fluidity.

While plasticity can be increased by the shearing force applied to the rubber according to the aforementioned method, a step of properly adding a softener or the like generally employed for producing rubber products in such a range that the rubber can maintain desired characteristics or the like may be further added.

The obtained recycled rubber is preferably introduced in a mastication step for raw material rubber. In other words, the recycled rubber is kneaded by a kneader or the like along with the virgin rubber in the mastication step for obtaining a recycled compound, which in turn is molded and vulcanized into a cylindrical form or the like by extrusion molding or heat/pressure molding, for example. The recycled rubber and the virgin rubber can be homogeneously mixed with each other in a short time according to this method, whereby the rubber roller containing the recycled rubber can be simply produced at a low cost. Finally, the molded recycled rubber is inserted into a core bar, and finishing such as polishing of the surface is performed.

A recycled rubber roller having physical properties substantially equivalent to the original physical properties can be produced through the aforementioned step. After the recycled rubber roller is used, the rubber part is recycled through a step similar to the first recycling step, to produce a recycled rubber roller again. It is possible to semipermanently recycle the rubber part while hardly reducing the performance of the rubber roller by repeating recycling in the aforementioned manner.

In the conductive rubber roller according to the present invention, the rubber part may have a composition generally employed as that for a conductive rubber roller for OA.

Natural rubber (NR), butadiene rubber, isoprene rubber, styrene-butadiene rubber (SBR), ethylene-propylene-diene terpolymer rubber (EPDM), butyl rubber, silicon rubber or the like can be employed as a rubber component, in addition to rubber having ion conductivity such as epichlorohidrin rubber, urethane rubber, nitrile-butadiene rubber, acrylic rubber, chloroprene rubber, fluororubber, nitrile rubber or norbornene rubber. These may be singularly employed or may be employed as a mixture of at least two types. Among these, epichlorohidrin rubber is preferably employed in a point that the same has excellent ion conductivity and physical properties.

While there are sulfuric organic compounds such as sulfur, tetraalkylthiuram-disulfide, morpholine-disulfide and alkyl-phenol-disulfide, a metal compound such a magnesium oxide, oximes such as p-quinone-oxime and p,p′-dibenzoyl-quinone dioxime, peroxides such as dicumyl-peroxide and benzoyl-peroxide, sulfur chloride, selenium and tellurium as vulcanizers, sulfur is preferable in a point that the same is at a low cost and easy to obtain, has a sufficiently high vulcanizing function and is excellent in wear resistance of a rubber roller surface.

As vulcanization accelerators, there are thiazoles such as dibenzothiazolyl disulfide (DM), 2-mercaptobenzothiazole (D) and 2-mercaptobenzothiazole zinc salt (MZ), sulfenic amides such as diisopropyl sulfeneamide (DIBS) and cyclohexyl sulfeneamide (CZ), thiurams such as tetramethylthiuram disulfide (TT), tetraethylthiuram-disulfide (TET) and dipentamethylenethiuram-tetrasulfide (TRA) and dithonate such as diethyldithiocarbamate zinc salt (EZ) as well as guanidines, thioureas, aldehyde ammonias and xanthates. Thiazoles are preferable, and DM is particularly preferable, in points accelerating reaction between the rubber component and the vulcanizer, attaining reduction of the vulcanization time, reduction of the vulcanization temperature and reduction of the quantity of sulfur and improving breaking strength and wear resistance of the rubber roller. Sulfenic amides are also preferable, and CZ is particularly preferable, in a point slower to scorch and faster to start vulcanization than thiazoles.

As the vulcanization accelerator, a metal oxide such as zinc white or aliphatic acid such as zinc stearate or oleic acid can be listed.

Further, a softener, a plasticizer, a reinforcing agent or the like can be properly blended in addition to an aminic or phenolic age resistor and a filler such as carbon, silica, clay, cork, talc, calcium carbonate, dibasic lead phosphate (DLP), basic magnesium carbonate or alumina.

### EXAMPLES

While the present invention is now described in more detail with reference to Examples, the present invention is not restricted to these.

(1) Production of Rubber Roller

### Examples 1 to 3

<Production of Virgin Rubber Roller>

Epichlorohidrin rubber and NBR were masticated in a kneader with loadings shown in Table 1, and rubber compounds were obtained by successively introducing stearic acid, zinc white, carbon, vulcanization accelerators and sulfur into the kneader and kneading the same. Rubber rollers were obtained by extrusion-molding these into cylindrical forms, steam-vulcanizing the same under a load of 4 kgf/cm² (3.92266×10⁵ Pa) at 150° C. for 50 minutes, inserting the same into stainless core bars and thereafter polishing the rubber surfaces.

TABLE 1

| Compounding | Example | Comparative Example |
|---|---|---|
| Ingredient | (part by mass) | (part by mass) |
| Recycled Rubber | 2X | — |
| Epichlorohidrin | 50-X | 50 |
| Rubber^{(note1)} | | |
| NBR^{(note2)} | 50-X | 50 |
| Stearic Acid | 1.0 | 1.0 |
| Zinc White | 5.0 | 5.0 |
| Carbon^{(note3)} | 20 | 20 |
| Vulcanization | 1.0 | 1.0 |
| Accelerator A^{(note4)} | | |
| Vulcanization | 2.0 | 2.0 |
| Accelerator B^{(note5)} | | |
| Vulcanizer^{(note6)} | 1.0 | 1.0 |

^{(note1)}Epichlorohidrin rubber is a terpolymer of ethylene oxide, allyl glycidyl ether and epichlorohidrin.
^{(note2)}NBR is low-nitrile NBR.
^{(note3)}Carbon is thermal black.
^{(note4)}Vulcanization accelerator A is tetramethylthiuram disulfide (TT).
^{(note5)}Vulcanization accelerator B is dibenzothiazolyl disulfide (DM).
^{(note6)}Vulcanizer is sulfur.

<Production of Recycled Rubber Roller>

Rubber parts were extracted from the core bars of the produced virgin rubber rollers and micropulverized through milling rollers of 10 inches for triturating the rubber in a state gradually narrowing the roll width so that the roll width finally unlimitedly approximates zero, thereby obtaining sheetlike recycled rubber.

The obtained recycled rubber was introduced in loadings shown in Tables 1 and 2 in mastication of epichlorohidrin rubber and NBR, and stearic acid, zinc white, carbon, vulcanization accelerators and sulfur of loadings shown in Table 1 were successively introduced into the kneader and kneaded to obtain recycled compounds. Recycled rubber rollers were obtained by extrusion-molding these into cylindrical forms, steam-vulcanizing the same under a load of 4 kgf/cm² (3.92266×10⁵ Pa) at 150° C. for 50 minutes, inserting the same into stainless core bars and thereafter polishing the rubber surfaces. The characteristics were evaluated as to the rubber parts of the obtained recycled rubber rollers. Table 2 shows the results.

TABLE 2

| | | | | | | | | | Comparative |
|---|---|---|---|---|---|---|---|---|---|
| | | Example 1 | Example 2 | Example 3 | Example 4 | Example 5 | Example 6 | Example 7 | Example |
| Loading of | | 10 | 20 | 30 | 10 | 10 | 10 | 10 | 0 |
| Recycled Rubber 2X | | | | | | | | | |
| Mooney Viscosity | | 50 | 53 | 55 | 52 | 50 | 51 | 52 | 49 |
| Rubber Hardness (°) | | 51 | 50 | 49 | 51 | 51 | 51 | 51 | 51 |
| T10 (min) | | 2.7 | 2.6 | 2.8 | 2.7 | 2.8 | 2.6 | 2.8 | 2.9 |
| Permanent | | 17.5 | 18.4 | 19.3 | 17.9 | 18 | 17.8 | 18 | 16.9 |
| Compressive Set | | | | | | | | | |
| (%) | | | | | | | | | |
| Breaking Strength | | 4.8 | 4.2 | 3.8 | 4.8 | 4.7 | 4.7 | 4.8 | 4.9 |
| (MPa) | | | | | | | | | |
| Breaking Extension | | 340 | 351 | 362 | 343 | 340 | 340 | 342 | 325 |
| (%) | | | | | | | | | |
| Tearing Strength | | 18.5 | 17.0 | 15.8 | 18.1 | 17.9 | 18.1 | 18.1 | 19.8 |
| (N/mm) | | | | | | | | | |
| Electric | 10° C. | 48 | — | — | 50 | 48 | 46 | 48 | 47 |
| Resistance | 15% | | | | | | | | |
| (E+06Ω) | 22° C. | 12 | 12 | 11 | 14 | 14 | 12 | 13 | 13 |
| | 55% | | | | | | | | |
| | 28° C. | 5.5 | — | — | 5.7 | 5.7 | 5.0 | 5.5 | 5.3 |
| | 85% | | | | | | | | |

### Examples 4 to 7

A recycled rubber roller according to Example 4 was produced from the recycled rubber roller according to Example 1 by a method similar to that for producing the recycled rubber roller according to Example 1 from the virgin rubber roller. Thereafter similar steps were repeated, for producing a rubber roller according to Example 5 from the rubber roller according to Example 4, a rubber roller according to Example 6 from the rubber roller according to Example 5 and a rubber roller according to Example 7 from the rubber roller according to Example 6 respectively. Table 2 shows results of characteristic evaluation performed as to rubber parts of the obtained recycled rubber rollers.

### Comparative Example

Characteristic evaluation was performed as to the rubber parts of the virgin rubber rollers produced by the aforementioned method. Table 2 shows the results.

Characteristic evaluation as to the rubber parts was performed as follows:

(2) Mooney Viscosity

Measurement was performed at 100° C. according to JIS-K6300-1.

(3) Rubber Hardness

Four portions were selected and measured with a JIS-A hardness meter at 23° C. in the forms of the rubber rollers, for obtaining average values.

(4) T10

Rise times T10 of vulcanization were obtained at 160° C. by employing a rheometer vulcanization tester (by Toyo Seiki Co., Ltd.). T10=10×(maximum torque−minimum torque)/100.

(5) Permanent Compressive Set

Measurement was performed by setting a compression ratio to 25%, a test temperature to 70° C. and a test time to 24 hours according to JIS-K6262.

(6) Breaking Strength

Measurement was performed by using a dumbbell-shaped No. 3 according to JIS-K6251.

(7) Breaking Extension

Measurement was performed by using a dumbbell-shaped No. 3 according to JIS-K6251.

(8) Tearing Strength

Measurement was performed by using a dumbbell-shaped No. 3 according to JIS-K6252.

(9) Electric Resistance

Brought into contact with a revolving metal roll of 30 mm in diameter at 1 kg in the forms of rubber rollers and a DC voltage of 100 V was applied with a resistance meter (“R8340A” by Advantest Corporation) for obtaining average values from maximum and minimum current values after 30 seconds.

No remarkable reduction is recognized as compared with comparative example in Mooney viscosity, rubber hardness, T10, permanent compressive set, breaking strength, breaking extension, tearing strength and electric resistance values of Examples 1 to 7. Therefore, it is understood that a conductive rubber roller having characteristics favorably comparable with those of a rubber roller composed of only virgin rubber can be obtained also when 10 to 30 mass % of recycled rubber is introduced. Further, the aforementioned characteristic values exhibited no remarkable reduction when recycling was repeated, whereby it is understood possible to semipermanently recycle the rubber part of the conductive rubber roller by applying the present invention.

An embodiment and Examples disclosed this time must be considered as illustrative and not restrictive in all points. The scope of the present invention is shown not by the above description but the scope of claim for patent, and it is intended that all modifications within the meaning and range equivalent to the scope of claim for patent are included.

### INDUSTRIAL APPLICABILITY

According to the present invention, it is possible to produce a recycled rubber roller without remarkably reducing the physical properties of a rubber part by using recycled rubber obtained by separating only the rubber part from a conductive rubber roller as that for the conductive rubber roller again. Since the recovered rubber part is used for the same application, no remarkable physical property reduction results in the rubber part also when recycling is repeated a plurality of times but the rubber part can be semipermanently recycled. Thus, reduction of the cost as well as effective exploitation of resources are enabled.

1. A conductive rubber roller for OA whose rubber part is constituted of rubber containing recycled rubber.

2. The conductive rubber roller for OA according to claim 1, provided with conductivity by ionic conduction.

3. The conductive rubber roller for OA according to claim 1, provided with conductivity by electronic conduction.

4. The conductive rubber roller for OA according to claim 1, wherein the content of the recycled rubber in the rubber part is in the range of 5 to 50 mass %.

5. A process for producing the conductive rubber roller for OA according to claim 1, including steps of obtaining micropulverized rubber by micropulverizing rubber separated from a rubber roller;
obtaining recycled rubber by increasing fluidity of said micropulverized rubber by physical treatment and/or heat treatment; and
mixing said recycled rubber with virgin rubber.
